(19) United States
(12) Patent Application Publication
(10) Pub. No.: US 2013/0285348 A1
(43) Pub. Date: Oct. 31, 2013

(54) ADJUSTABLE TOWING SYSTEM AND METHOD

(71) Applicants: Paul Schmitt, Boonsboro, PA (US); Michael B. Pruden, Colfax, NC (US)

(72) Inventors: Paul Schmitt, Boonsboro, PA (US); Michael B. Pruden, Colfax, NC (US)

(73) Assignee: VOLVO TECHNOLOGY OF AMERICA, INC., Greensboro, NC (US)

(21) Appl. No.: 13/979,873

(22) PCT Filed: Jan. 17, 2011
(86) PCT No.: PCT/US11/21448

§ 371 Date: Jul. 16, 2013

(51) Int. Cl. B62D 53/08

(52) U.S. Cl. CPC B62D 53/0814
USPC 280/438.1

(57) ABSTRACT

The present invention relates to an adjustable towing system and method for a towing vehicle and a towed vehicle. A towing anchor is located on the towing vehicle. A towed anchor is located on the towed vehicle and connected to the towing anchor, whereby the towing vehicle tows the towed vehicle. A gap is defined between the towing vehicle and the towed vehicle. The gap is provided with a length. At least one locking device selectively locks and unlocks the position of the towing anchor or the towed anchor, whereby as the towing vehicle and towed vehicle travel, relative speed differentials between the towing vehicle and towed vehicle produce repositioning of at least one of the towing anchor or the towed anchor in order to adjust the length of the gap.

### FIELD OF THE INVENTION

The present invention relates to an adjustable towing system and method for adjusting the gap between a towed vehicle and a towing vehicle during towing operations.

### BACKGROUND OF THE INVENTION

Many vehicles, including automobiles, trucks, truck tractors, boats, and trains, are used to tow other vehicles, including, for example, trailers, barges, and train cars. Regardless of the type of towing vehicle and towed vehicle, fuel efficiency can be markedly decreased due to aerodynamic drag. A significant source of drag is attributable to any gap between the towing vehicle and the towed vehicle. For example, in the context of truck tractors, one study has shown that the drag due to the gap between the truck tractor and the trailer accounts for a 20% fuel economy reduction. (“Air Flow Testing on Aerodynamic Truck”, NASA Dryden Flight Research Center, 1975)

To reduce drag in the trucking industry, aerodynamic gap fairings have been employed on trailers. The fairings reduce drag by diverting air flow that would normally flow into the gap. While somewhat effective for reducing drag, fairings increase the weight of the trailer, which, in turn, decreases fuel efficiency. Furthermore, installation time and expense can be significant since a fairing system must be installed on each semi-trailer.

A more recently proposed approach to reducing gap drag is to employ adjustable fifth wheel hitches on tractor trucks. The adjustable fifth wheel allows the gap distance to be adjusted “on the fly” as the truck tractor travels. In particular, when traveling at high speed, the adjustable fifth wheel slides forward to reduce the size of the gap and when traveling at low speeds the adjustable fifth wheel slides rearward in order to increase the size of the gap and to allow for full trailer articulation during turning. The currently known systems are electronically controlled systems that used geared or hydraulic motors to adjust the position of the fifth wheel. Due to the large carrying capacity of fully laden trailers, however, the motor and repositioning mechanism need to be sizeable, which increases the weight of the truck tractor, which, in turn, decreases fuel efficiency. Furthermore, the energy required to push and pull a fully laden trailer (˜60 k lbs) is substantial and will likely offset much of the fuel economy benefit of such a system.

The present invention relates to an improved adjustable towing system and method wherein relative speed differentials between the towing vehicle and the towed vehicle decrease or increase the size of the gap between a towing vehicle and a towed vehicle as the towing vehicle and towed vehicle travel.

### SUMMARY OF THE INVENTION

According to one embodiment of the present invention, an adjustable towing system comprises a towing vehicle and a towed vehicle. A towing anchor is located on the towing vehicle. A towed anchor is located on the towed vehicle and connected to the towing anchor, whereby the towing vehicle tows the towed vehicle. A gap is defined between the towing vehicle and the towed vehicle. The gap is provided with a length. At least one locking device selectively locks and unlocks the position of the towing anchor or the towed anchor, whereby as the towing vehicle and towed vehicle travel, relative speed differentials between the towing vehicle and towed vehicle produce repositioning of at least one of the towing anchor or the towed anchor in order to adjust the length of the gap.

According to another embodiment of the present invention, a method for adjusting a length of a gap between a towed vehicle and a towing vehicle as the towing vehicle and towed vehicle travel is provided. A towing anchor is located on the towing vehicle. A towed anchor is located on the towed vehicle and connected to the towing anchor, whereby the towing vehicle tows the towed vehicle. A gap is defined between the towing vehicle and the towed vehicle and provided with a length. A locking device selectively locks and unlocks the position of the towing anchor or the towed anchor. The method comprises the step of using relative speed differentials between the towing vehicle and towed vehicle to produce repositioning of at least one of the towing anchor or the towed anchor in order to adjust the length of the gap as the towing vehicle and towed vehicle travel.

### Aspects

According to one aspect of the present invention, an adjustable towing system comprises:
a towing vehicle;
a towed vehicle;
a towing anchor located on the towing vehicle;
a towed anchor located on the towed vehicle and connected to the towing anchor, whereby the towing vehicle tows the towed vehicle;
a gap defined between the towing vehicle and the towed vehicle, wherein said gap is provided with a length; and
at least one locking device that selectively locks and unlocks the position of the towing anchor or the towed anchor, whereby as the towing vehicle and towed vehicle travel, relative speed differentials between the towing vehicle and towed vehicle produce repositioning of at least one of the towing anchor or the towed anchor in order to adjust the length of the gap.

Preferably, at least one of the towing anchor or the towed anchor is repositionable longitudinally along the respective towing vehicle or the towed vehicle.

Preferably, the at least one locking device includes a first locking device and a second locking device, the first locking device selectively locks and unlocks the position of the towing anchor, whereby as the towing vehicle and towed vehicle travel, relative speed differentials between the towing vehicle and towed vehicle produce repositioning of the towing anchor in order to adjust the length of the gap, and the second locking device selectively locks and unlocks the position of the towed anchor, whereby as the towing vehicle and towed vehicle travel, relative speed differentials between the towing vehicle and towed vehicle produce repositioning of the towed anchor in order to adjust the length of the gap.

Preferably, the towing vehicle is a truck tractor and the towing anchor is a fifth wheel and the towed vehicle is a trailer and the towed anchor is a kingpin.

Preferably, the system further comprises one or more electronics monitor the speed of at least one of the towing vehicle or towed vehicle and control the speed of at least one of the towing vehicle or the towed vehicle in order to generate the relative speed differentials.

Preferably, the system further comprises one or more electronics that control the locking and unlocking of the at least one locking device whereby as the towing vehicle and towed vehicle travel, relative speed differentials between the towing vehicle and towed vehicle produce repositioning of at least one of the towing anchor or the towed anchor in order to adjust the length of the gap.

Preferably, the towing vehicle includes at least one axle, the towed vehicle includes at least one axle, and the at least one locking device selectively locks and unlocks the position of the towing anchor or the towed anchor, whereby as the towing vehicle and towed vehicle travel, relative speed differentials between the towing vehicle and towed vehicle produce repositioning of at least one of the towing anchor or the towed anchor in order to adjust load on the axles and prevent axle overloading.

Preferably, the at least one locking device includes a worm and a traveling member that selectively locks the position of the towing anchor or towed anchor anywhere along a path of motion of the towing anchor or the towed anchor.

Preferably, the towing vehicle includes at least one axle, the towed vehicle includes at least one axle and a frame, and another locking device is provided that selectively locks and unlocks the position of the at least one axle on the towed vehicle, whereby as the towing vehicle and towed vehicle travel, relative speed differentials between the towed vehicle frame and the at least one axle of the towed vehicle produce repositioning of the at least one axle of the towed vehicle in order to adjust loads on the axles and prevent axle overloading.

Preferably, the at least one locking device includes a first locking device and a second locking device, the towing vehicle includes at least one axle, the towed vehicle includes at least one axle, another locking device is provided that selectively locks and unlocks the position of the at least one axle on the towed vehicle, whereby as the towing vehicle and towed vehicle travel, relative speed differentials between the towed vehicle frame and the at least one axle of the towed vehicle produce repositioning of the at least one axle of the towed vehicle in order to adjust loads on the axles and prevent axle overloading, the first locking device selectively locks and unlocks the position of the towing anchor, whereby as the towing vehicle and towed vehicle travel, relative speed differentials between the towing vehicle and towed vehicle produce repositioning the towing anchor in order to adjust the length of the gap, adjust the load on the axles, and prevent axle overloading, and the second locking device selectively locks and unlocks the position of the towed anchor, whereby as the towing vehicle and towed vehicle travel, relative speed differentials between the towing vehicle and towed vehicle produce repositioning of the towed anchor in order to adjust the length of the gap, adjust the load on the axles, and prevent axle overloading.

According to another embodiment of the present invention, a method for adjusting a length of a gap between a towed vehicle and a towing vehicle as the towing vehicle and towed vehicle travel is provided. A towing anchor is located on the towing vehicle. A towed anchor is located on the towed vehicle and connected to the towing anchor, whereby the towing vehicle tows the towed vehicle. A gap is defined between the towing vehicle and the towed vehicle and provided with a length. A locking device selectively locks and unlocks the position of the towing anchor or the towed anchor. The method comprises the step of using relative speed differentials between the towing vehicle and towed vehicle to produce repositioning of at least one of the towing anchor or the towed anchor in order to adjust the length of the gap as the towing vehicle and towed vehicle travel.

Preferably, the step of using relative speed differentials between the towing vehicle and towed vehicle to produce repositioning of at least one of the towing anchor or the towed anchor in order to adjust the length of the gap as the towing vehicle and towed vehicle travel includes the step of using relative speed differentials between the towing vehicle and towed vehicle to produce repositioning of at least one of the towing anchor or the towed anchor longitudinally along the towing vehicle or the towed vehicle in order to adjust the length of the gap as the towing vehicle and towed vehicle travel.

Preferably, the at least one locking device includes a first locking device and a second locking device, the first locking device selectively locks and unlocks the position of the towing anchor, the second locking device selectively locks and unlocks the position of the towed anchor and the step of using relative speed differentials between the towing vehicle and towed vehicle to produce repositioning of at least one of the towing anchor or the towed anchor in order to adjust the length of the gap as the towing vehicle and towed vehicle travel includes the step of using relative speed differentials between the towing vehicle and towed vehicle to produce repositioning of the towing anchor and the towed anchor in order to adjust the length of the gap as the towing vehicle and towed vehicle travel.

Preferably, the towing vehicle is a truck tractor and the towing anchor is a fifth wheel and the towed vehicle is a trailer and the towed anchor is a kingpin.

Preferably, the method further comprises the step of using one or more electronics to monitor the speed of at least one of the towing vehicle or towed vehicle and to control the speed of at least one of the towing vehicle or the towed vehicle in order to generate the relative speed differentials.

Preferably, the method further comprises the step of using one or more electronics to control the locking and unlocking of the at least one locking device whereby the relative speed differentials between the towing vehicle and towed vehicle may produce repositioning of at least one of the towing anchor or the towed anchor in order to adjust the length of the gap.

Preferably, the towing vehicle includes at least one axle, the towed vehicle includes at least one axle, and the method further comprises the step of using relative speed differentials between the towing vehicle and towed vehicle may produce repositioning of at least one of the towing anchor or the towed anchor in order to adjust load on the axles and prevent axle overloading.

Preferably, the at least one locking device includes a worm and a traveling member the selectively lock the position of the towing anchor or towed anchor anywhere along a path of motion of the towing anchor or the towed anchor.

Preferably, the towing vehicle includes at least one axle, the towed vehicle includes at least one axle and a frame, another locking device is provided that selectively locks and unlocks the position of the at least one axle on the towed vehicle, and the method further comprises the step of using relative speed differentials between the towed vehicle frame and the at least one axle of the towed vehicle to produce repositioning of the at least one axle of the towed vehicle in order to adjust loads on the axles and prevent axle overloading.

Preferably, the at least one locking device includes a first locking device and a second locking device, the towing vehicle includes at least one axle, the towed vehicle includes at least one axle, another locking device is provided that selectively locks and unlocks the position of the at least one axle on the towed vehicle, the first locking device selectively locks and unlocks the position of the towing anchor, the second locking device selectively locks and unlocks the position of the towed anchor, the step of using relative speed differentials between the towing vehicle and towed vehicle to produce repositioning of at least one of the towing anchor or the towed anchor in order to adjust the length of the gap as the towing vehicle and towed vehicle travel includes the steps of using relative speed differentials between the towing vehicle and towed vehicle to produce repositioning the towing anchor and the towed anchor in order to adjust the length of the gap, adjust the load on the axles, and prevent axle overloading, and the method further comprises the step of using relative speed differentials between the towed vehicle frame and the at least one axle of the towed vehicle to produce repositioning of the at least one axle of the towed vehicle in order to adjust loads on the axles and prevent axle overloading.

### BRIEF DESCRIPTION OF THE DRAWINGS

FIG. 1 illustrates a side view of a towing vehicle and a towed vehicle according to one embodiment.

FIG. 2 illustrates a side view of a towing vehicle and a towed vehicle according to one embodiment.

FIG. 3 illustrates a side view of a towing vehicle and a towed vehicle according to one embodiment.

FIG. 4 illustrates a top view of towing vehicle and a towed vehicle according to one embodiment.

FIG. 5 illustrates a side view of locking device and a side-sectional view of a towing anchor according to one embodiment.

FIG. 6 illustrates an underside view of a towing anchor and a locking device according to one embodiment.

FIG. 7 illustrates an underside view of a towed vehicle according to one embodiment.

FIG. 8 illustrates a side view of locking device and a side-sectional view of a towed anchor according to one embodiment.

FIG. 9 illustrates a top side view of a towed anchor and a locking device according to one embodiment.

FIG. 10 illustrates a schematic view of control system for an adjustable towing system of one embodiment.

### DETAILED DESCRIPTION OF THE INVENTION

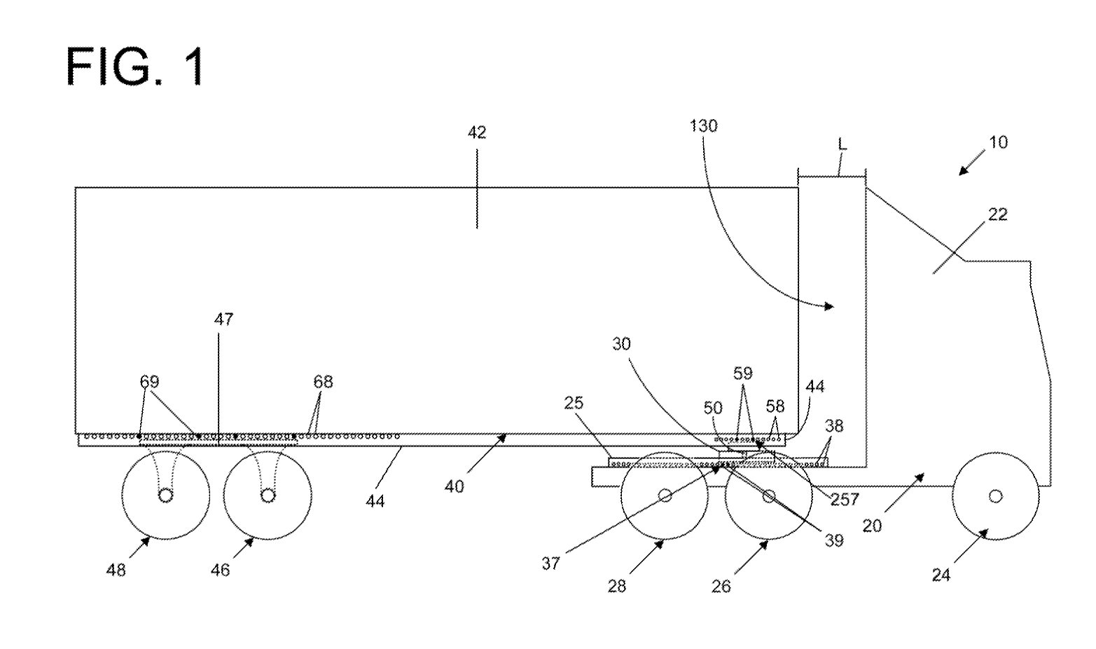

FIGS. 1-10 depict an adjustable towing system 10 according to one embodiment of the present invention. As shown therein, the adjustable towing system includes a towing vehicle and a towed vehicle, such as, for example towing vehicle 20 and towed vehicle 40.

Within the scope of the present invention, the towing vehicle and the towed vehicle may be any type of vehicle. Accordingly, as used herein, the term towing vehicle includes any vehicle that tows or pulls another vehicle and may include, but is not limited to, boats or ships that tow other vehicles, including barges and other ships or boats, towed barges that tow subsequent vehicles, including other barges, locomotives, towed train cars that tow subsequent vehicles, including subsequent train cars, truck tractors, light trucks, automobiles, or towed trailers that tow subsequent trailers, i.e. truck trailer trains. Furthermore, as used herein, the term towed vehicle includes any vehicle that is towed or is pulled by another vehicle and may include, but is not limited to, boats, ships, barges, locomotives, train cars, truck tractors, light trucks, automobiles, and trailers. By way of example, the principals of the present invention may be applied to each train car and the locomotives of a train and each trailer in a truck trailer train and the leading truck tractor of the truck trailer train.

In the embodiment depicted in FIGS. 1-10, the towing vehicle 20 is a truck tractor and the towed vehicle 40 is a trailer. As shown in FIGS. 1-3, the towing vehicle 20 may be provided with cab 22, front wheels and axle 24, at least one rear axle, including, for example, a pair of rear wheels and axles 26 and 28. Also shown, the towed vehicle 40 may be provided with cargo box 42, at least one axle, for example, a pair of rear wheels and axles 46, 48.

As shown in FIGS. 1-3, a towing anchor 30, located on the towing vehicle 20, is connected to the towed anchor 50, located on the towed vehicle 40, whereby the towing vehicle 20 may tow or pull the towed vehicle 40. In the present embodiment the towing anchor 30 is a fifth wheel and the towed anchor 50 is a kingpin.

As shown in FIGS. 1-3, when the towing anchor 30 is connected to the towed anchor 50 a longitudinally extending gap 130 is defined between the towing vehicle 20 and the towed vehicle 40. According to one aspect of the present embodiment, the gap 130 is provided with a length L that extends longitudinally from the towing vehicle 20 to the towed vehicle 40. According to another aspect of the present embodiment, the gap 130 is provided with a length L that extends longitudinally from the cab 22 of towing vehicle 20 to the cargo box 42 of the towed vehicle 40.

According to one aspect of the present embodiment, the towing anchor 30 may be repositioned along the towing vehicle 20 as the towing vehicle 20 and towed vehicle 40 travel, in order to adjust the length L of the gap 130. According to another aspect of the present embodiment, the repositioning of the towing anchor 30 may reduce the length L of the gap 130. According to yet another aspect of the present embodiment, the repositioning of the towing anchor 30 may reduce the length L of the gap 130 in order to increase the fuel efficiency of the truck tractor.

According to still another aspect of the present embodiment, the repositioning of the towing anchor 30 may increase the length L of the gap 130. According to still yet another aspect of the present embodiment, the repositioning of the towing anchor 30 may increase the length L of the gap 130 in order to increase the range of towed vehicle 40 articulation, relative to the towing vehicle 20, such as, for example during turning. According to yet a further aspect of the present embodiment, the repositioning of the towing anchor 30 may increase the length L of the gap 130 in anticipation of a the occurrence of an accident, for example an impact of the towing vehicle 20 or the towed vehicle 40 with another vehicle or object.

According to one aspect of the present embodiment, the towing anchor 30 may be repositioned along the towing vehicle 20 as the towing vehicle 20 and towed vehicle 40 travel, whereby axle load is determined according to the position of the towing anchor 30. According to still a further aspect of the present embodiment, the towing anchor 30 may be repositioned along the towing vehicle 20 as the towing vehicle 20 and towed vehicle 40 travel in order to adjust the load on the axles 24, 26, 28 and in order to prevent the overloading of the axles 24, 26, 28.

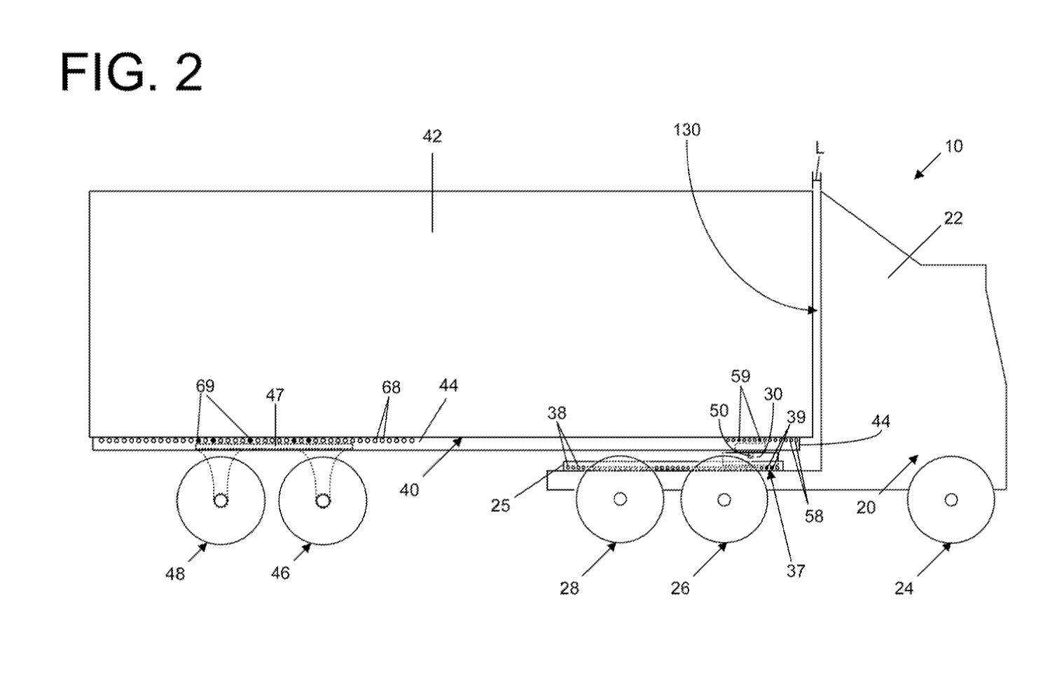

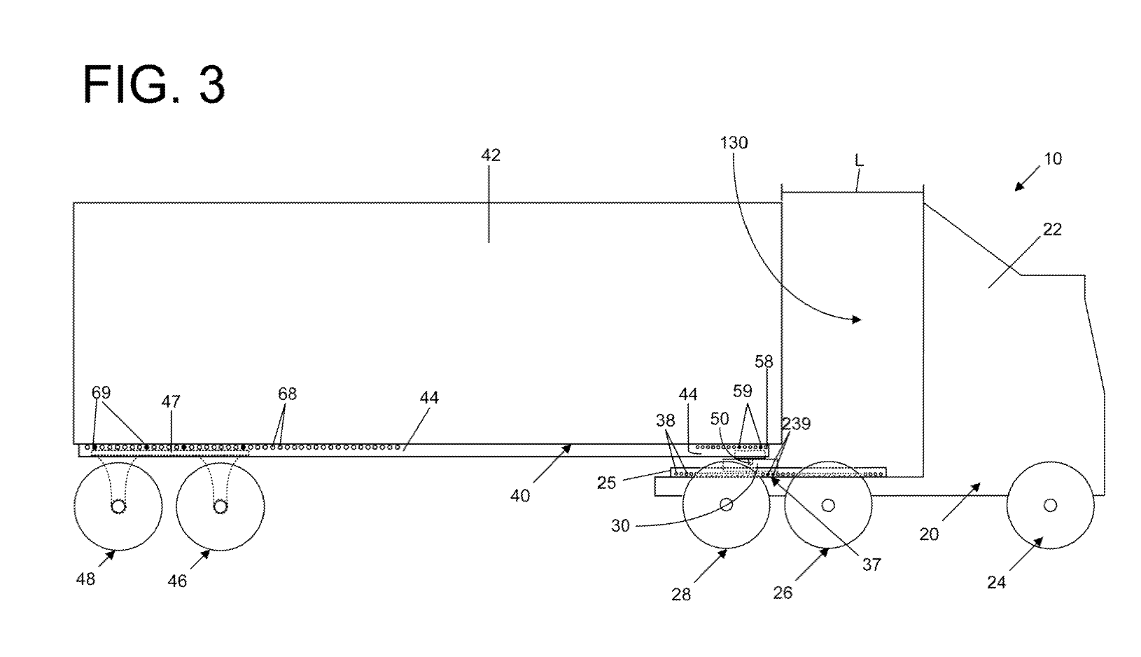

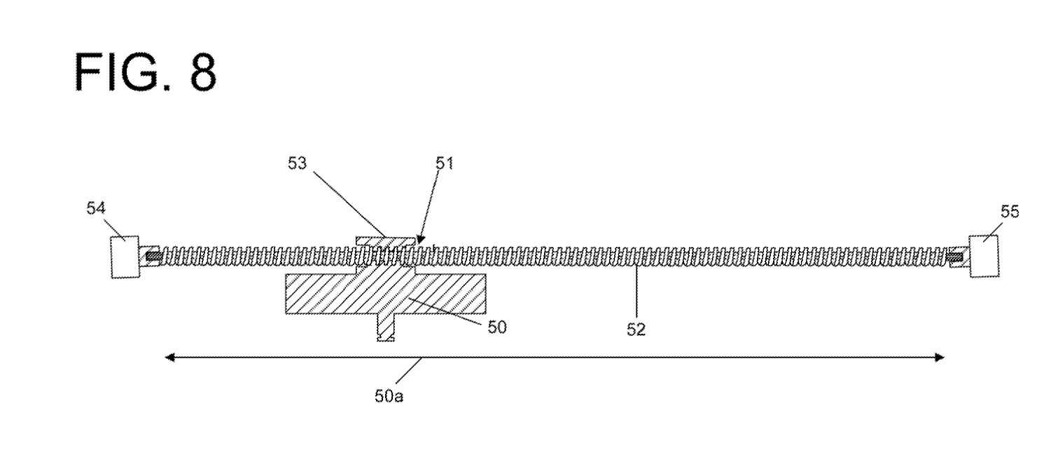

As shown in FIG. 2, as compared to FIGS. 1 and 3, as the towing vehicle 20 and the towed vehicle 40 travel, the towing anchor 30 may be moved forward along the towing vehicle 20 in order to decrease the length L of the gap 130. As shown in FIG. 3, as compared to FIGS. 1 and 2, as the towing vehicle 20 and the towed vehicle 40 travel, the towing anchor 30 may be moved rearward along the towing vehicle 20 in order to increase the length L of the gap 130. Those of ordinary skill in the art will also appreciate that as the towing anchor 30 is repositioned, as shown in FIGS. 8-10, that the load distribution on the axles 24, 26, and 28 is adjusted.

According to yet another aspect of the present embodiment, relative speed differentials between the towing vehicle 20 and the towed vehicle 40 produce repositioning of the towing anchor 30. Advantageously, as hereinafter discussed, one or more electronics 120 may monitor and/or control the speeds of the towing vehicle 20 and/or the towed vehicle 40 for purposes of producing repositioning of the towing anchor 30 in response to relative speed differentials between the towing vehicle 20 and the towed vehicle 40.

According to one aspect of the present embodiment, a locking device selectively locks and unlocks the position of the towing anchor 30 along the towing vehicle 20, whereby as the towing vehicle 20 and towed vehicle 40 travel, relative speed differentials between the towing vehicle 20 and towed vehicle 40 may produce repositioning of the towing anchor 30. It is within the scope of the present embodiment to utilize any type of device that is capable of selectively locking the position of the towing anchor 30, including, but not limited to, any pneumatically, hydraulically, mechanically, or electrically devices.

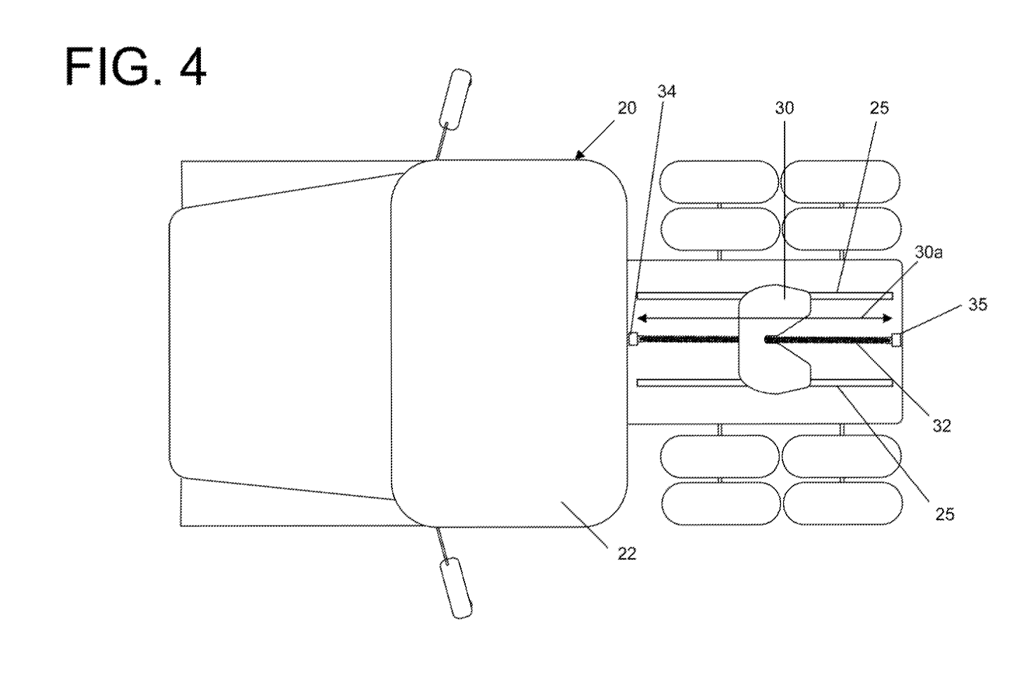

Turning now to FIGS. 4-6, by way of example and not limitation, in embodiments, a worm type locking device 31 may be employed. As shown therein, the locking device 31 may include a worm 32 and a traveling member 33. As shown, the traveling member 33 may extend circumferentially around the worm 32, whereby the threads of each intermesh. Also shown, the traveling member 33 may be secured to the towing anchor 30.

Those of ordinary skill in the art will appreciate that as the towing vehicle 20 tows the towed vehicle 40 that the towed anchor 50 pulls on the towing anchor 30 in a direction rearward direction, for example during acceleration of the towing vehicle 20. Those of ordinary skill in the art will appreciate that as the towing vehicle 20 tows the towed vehicle 40 that the towed anchor 50 pushes on the towing anchor in a forward direction, for example during deceleration of the towing vehicle 20. Those of ordinary skill in the art will appreciate that as the towed anchor 50 pulls or pushes on the towing anchor 30, that the longitudinal force vectors of these actions include a circumferential force component due to the helical nature of the threads (not shown) on the worm 32 and the traveling member 33.

Advantageously, the intermeshing of the threads on the worm 32 and the traveling member 33 selectively lock the traveling member 33 and the towing anchor 30 in place so long as the circumferential force component is insufficient to overcome the friction between the threads. Those of ordinary skill in the art will appreciate that the angle of the threads and the dimension of the flanks of the threads may be designed to provide a sufficient level of frictional force between the worm 32 and the traveling member 33 and selectively inhibit longitudinal movement of the towing anchor 30 along the path of motion 30a of the towing anchor 30 and therefore selectively lock the position of the towing anchor 30 along the path of motion 30a.

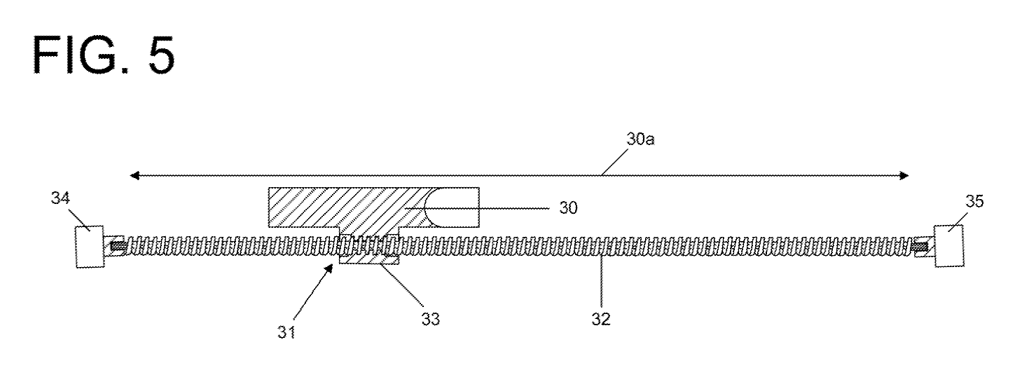

As shown in FIG. 5, to permit repositioning of the towing anchor 30, the worm 32 may be rotated via at least one torquing member, for example, torquing members 34, 35, which may, for example, and not limitation, be pneumatically, hydraulically, or electrically driven motors. Advantageously, the torquing members 34, 35 need only supply sufficient torsional force to overcome the frictional force between the worm 32 and the traveling member 33 to permit longitudinal movement of the towing anchor 30 in response to relative speed differentials between the towing vehicle 20 and the towed vehicle 40. In particular, as the worm 32 rotates and the towed anchor 50 pulls or pushes on the towing anchor 30, the towing anchor 30 may be urged to travel longitudinally along the towing vehicle 20 and along path of motion 30a in response to relative speed differentials between the towing vehicle 20 and the towed vehicle 40.

By way of example, and not limitation, the torquing members 34, 35 may rotate the worm 32 in a first direction, in a manner that overcomes frictional forces between the worm 32 and the traveling member 33. As this occurs, brakes to the towing vehicle 20 may be applied, for example, such that the towed vehicle 40 is caused to travel at a speed that exceeds the speed of the towing vehicle 20. As the towed vehicle 40 travels at a speed that exceeds the speed of the towing vehicle 20, the towed anchor 50 of the towed vehicle 40 may push on and urge the towing anchor 30 forward along the towing vehicle 20 and produce repositioning of the towing anchor 30 forward along the towing vehicle 20. Those of ordinary skill in the art will appreciate that in this manner the length L of the gap 130 may be decreased.

By way of another example, and not limitation, the torquing members 34, 35 may rotate the worm 32 in a second direction, opposite to the first direction, in a manner that is sufficient to overcome frictional forces between the worm 32 and the traveling member 33. As this occurs, brakes to the towed vehicle 40 may be applied, such that the towing vehicle 20 is caused to travel at a speed that exceeds the speed of the towed vehicle 40. As the towing vehicle 20 travels at a speed that exceeds the speed of the towed vehicle 40, the towed anchor 50 of the towed vehicle 40 may pull on and urge the towing anchor 30 rearward along the towing vehicle 20 and produce repositioning of the towing anchor 30 rearward along the towing vehicle 20. Those of ordinary skill in the art will appreciate that in this manner the length L of the gap 130 may be increased.

Advantageously, rather than requiring the use of relatively large, heavy, and powerful torquing members 34, 35 to both overcome the frictional force between the worm 32 and traveling member 33 and exert sufficient longitudinal force components to produce repositioning of the towing anchor 30 (and the accompanying mass of the towed vehicle 40), smaller, lighter, and less powerful torquing members 34, 35 may be used to overcome the frictional forces between the worm 32 and the traveling member 33 and the longitudinal force components required to produce repositioning of the towing anchor 30 may be generated, at least in part, and preferably, primarily, as a consequence of inertia and relative speed differentials between the towing vehicle 20 and the towed vehicle 40.

Upon the towing anchor 30 attaining a desired position, the torque members 34, 35, may cease rotating the worm 32, whereupon frictional forces between the worm 32 and the traveling member 33 once again lock the position of the towing anchor 30 in place. Those of ordinary skill in the art will appreciate that in this manner the towing anchor 30 may be selectively locked and unlocked in any position anywhere along a path of motion 30a of the towing anchor 30.

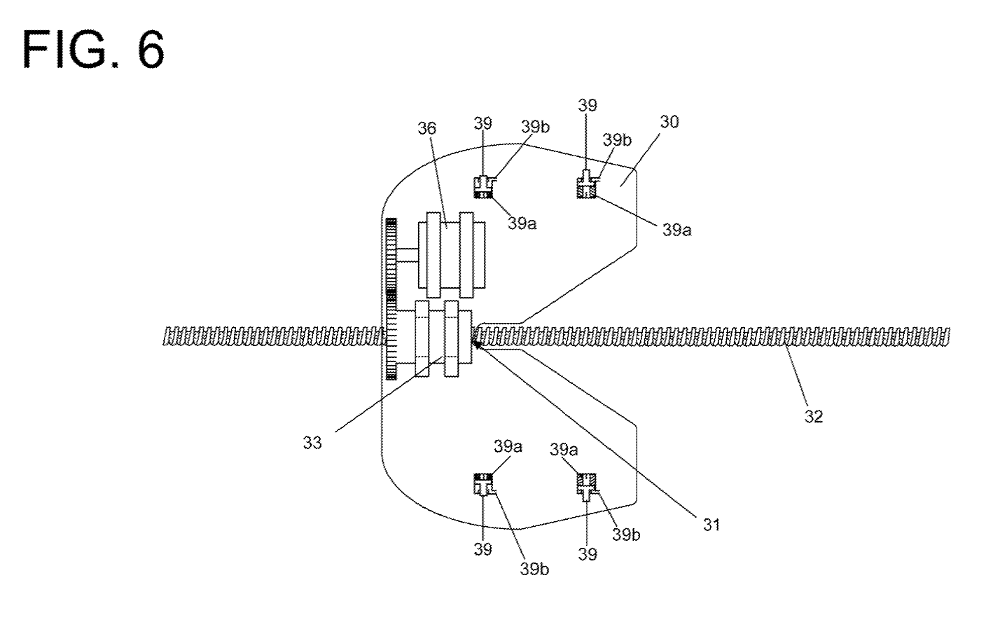

Alternatively or additionally, as shown in FIG. 6, in embodiments, the traveling member 33 may be rotated via at least one torquing member, for example, torquing member 36, which may, for example and not limitation, be pneumatically, hydraulically, or an electrically driven motor, to permit repositioning of the towing anchor 30. Advantageously, the torquing member 36 need only supply sufficient torsional force to overcome the frictional force between the worm 32 and the traveling member 33 to permit longitudinal movement of the towing anchor 30 in response to relative speed differentials between the towing vehicle 20 and the towed vehicle 40. In particular, as the traveling member 33 rotates and the towed anchor 50 pulls on or pushes on the towing anchor 30, the towing anchor 30 to may be urged to travel longitudinally along the towing vehicle 20 and along path of motion 30a in response to relative speed differentials between the towing vehicle 20 and the towed vehicle 40.

By way of example, and not limitation, the torquing member 36 may rotate the traveling member 33 in a first direction, in a manner that is sufficient to overcome frictional forces between the worm 32 and the traveling member 33. As this occurs, brakes to the towing vehicle 20 may be applied, for example, such that the towed vehicle 40 is caused to travel at a speed that exceeds the speed of the towing vehicle 20. As the towed vehicle 40 travels at a speed that exceeds the speed of the towing vehicle 20, the towed anchor 50 of the towed vehicle 40 may push on and urge the towing anchor 30 forward along the towing vehicle 20 and produce repositioning of the towing anchor 30 forward along the towing vehicle 20. Those of ordinary skill in the art will appreciate that in this manner the length L of the gap 130 may be decreased.

By way of another example, and not limitation, the torquing member 36 may rotate the traveling member 33 in a second direction, opposite to the first direction, in a manner that is sufficient to overcome frictional forces between the worm 32 and the traveling member 33. As this occurs, brakes to the towed vehicle 40 may be applied, such that the towing vehicle 20 is caused to travel at a speed that exceeds the speed of the towed vehicle 40. As the towing vehicle 20 travels at a speed that exceeds the speed of the towed vehicle 40, the towed anchor 50 of the towed vehicle 40 may pull on and urge the towing anchor 30 rearward along the towing vehicle 20 and produce repositioning of the towing anchor 30 rearward along the towing vehicle 20. Those of ordinary skill in the art will appreciate that in this manner the length L of the gap 130 may be increased.

Advantageously, rather than requiring the use of a relatively large, heavy, and powerful torquing member 36 to both overcome the frictional force between the worm 32 and traveling member 33 and exert sufficient longitudinal force components to produce repositioning of the towing anchor 30 (and the accompanying mass of the towed vehicle 40), a smaller, lighter, and less powerful torquing member 36 may be used to overcome the frictional forces between the worm 32 and the traveling member 33 and the longitudinal force components required to produce repositioning of the towing anchor 30 may be generated, at least in part, and preferably, primarily, as a consequence of inertia and relative speed differentials between the towing vehicle 20 and the towed vehicle 40.

Upon the towing anchor 30 attaining a desired position, the torque member 36 may cease rotating the traveling member 33, whereupon frictional forces between the worm 32 and the traveling member 33 once again lock the position of the towing anchor 30 in place. Those of ordinary skill in the art will appreciate that in this manner the towing anchor 30 may be selectively locked and unlocked in any position anywhere along a path of motion 30a of the towing anchor 30.

While it is within the scope of embodiments to utilize alternative types of locking devices, advantageously, a worm type locking devices 31 provides a greater degree of flexibility in locking the position of the towing anchor 30 anywhere along the path of motion 30a of the towing anchor 30. Furthermore, while it is in the scope of embodiments to rotate either the worm 32 or the traveling member 33, rotating both at the same time in opposite directions may also occur.

Turning now to FIGS. 1-3 and 6, by way of example, and not limitation, a locking device 37 of an alternative embodiment is depicted. As shown therein, the locking device 37 may include a plurality of locking passages 38 and one or more locking pins 39. As shown, in FIGS. 1-3, the passages 38 may be defined within a towing anchor track member 25 along which the towing anchor 30 slides or rolls along during repositioning. As shown in FIG. 6, the towing anchor 30 may include a plurality of locking pins 39 that are retractable to permit movement of the towing anchor 30 and extendable to lock the position of the towing anchor 30 in place. As shown, the locking pins 39 may be biased in an extended position by a spring 39a and may be retracted via pneumatic or hydraulic pressure supplied via port 39b. Advantageously, biasing the locking pins 39 in the extended position prevents movement of the towing anchor 30 in the event the pneumatic or hydraulic pressure supplied via port 39b fails.

According to another aspect of the present embodiment, as hereinafter discussed, one or more electronics 120 may control any locking device associated with the towing anchor 30, including, but not limited to, locking devices 31 and 37 for purposes of permitting relative speed differentials between the towing vehicle 20 and the towed vehicle 40 to produce repositioning of the towing anchor 30.

According to one aspect of the present embodiment, the towed anchor 50 may be repositioned along the towed vehicle 40 as the towing vehicle 20 and towed vehicle 40 travel, in order to adjust the length L of the gap 130. According to another aspect of the present embodiment, the repositioning of the towed anchor 50 may reduce the length L of the gap 130. According to yet another aspect of the present embodiment, the repositioning of the towed anchor 50 may reduce the length L of the gap 130 in order to increase the fuel efficiency of the towing vehicle 20.

According to still another aspect of the present embodiment, the repositioning of the towed anchor 50 may increase the length L of the gap 130. According to still yet another aspect of the present embodiment, the repositioning of the towed anchor 50 may increase the length L of the gap 130 in order to increase the range of towed vehicle 40 articulation, relative to the towing vehicle 20, such as, for example during turning. According to yet a further aspect of the present embodiment, the repositioning of the towed anchor 50 may increase the length L of the gap 130 in anticipation of the occurrence of an accident, for example an impact of the towing vehicle 20 or the towed vehicle 40 with another vehicle or object.

According to one aspect of the present embodiment, the towed anchor 50 may be repositioned along the towed vehicle 40 as the towing vehicle 20 and towed vehicle 40 travel, whereby axle load is determined according to the position of the towed anchor 50. According to still a further aspect of the present embodiment, the towed anchor 50 may be repositioned along the towing vehicle 20 as the towing vehicle 20 and towed vehicle 40 travel in order to adjust the load on the axles 24, 26, 28, 46, 48 and prevent the overloading of the axles 24, 26, 28, 46, 48.

As shown in FIG. 2, as compared to FIGS. 1 and 3, as the towing vehicle 20 and the towed vehicle 40 travel, the towed anchor 50 may be moved rearward along the towed vehicle 40 in order to decrease the length L of the gap 130. As shown in FIG. 3, as compared to FIGS. 1 and 2, as the towing vehicle 20 and the towed vehicle 40 travel, the towed anchor 50 may be moved forward along the towed vehicle 40 in order to increase the length L of the gap 130. Those of ordinary skill in the art will also appreciate that as the towed anchor 50 is repositioned, as shown in FIGS. 1-3 that the load distribution on the axles 24, 26, 28, 46, and 48 is adjusted.

According to yet another aspect of the present embodiment, relative speed differentials between the towing vehicle 20 and the towed vehicle 40 produce repositioning of the towed anchor 50. Advantageously, as hereinafter discussed, one or more electronics 120 may monitor and/or control the speeds of the towing vehicle 20 and/or the towed vehicle 40 for purposes of producing repositioning of the towed anchor 50 in response to relative speed differentials between the towing vehicle 20 and the towed vehicle 40.

According to one aspect of the present embodiment, a locking device selectively locks and unlocks the position of the towed anchor 50 along the towed vehicle 40, whereby as the towing vehicle 20 and towed vehicle 40 travel, relative speed differentials between the towing vehicle 20 and towed vehicle 40 may produce repositioning of the towed anchor 50. It is within the scope of the present embodiment to utilize any type of device that is capable of selectively locking the position of the towed anchor 50, including, but not limited to, any pneumatically, hydraulically, mechanically, or electrically devices.

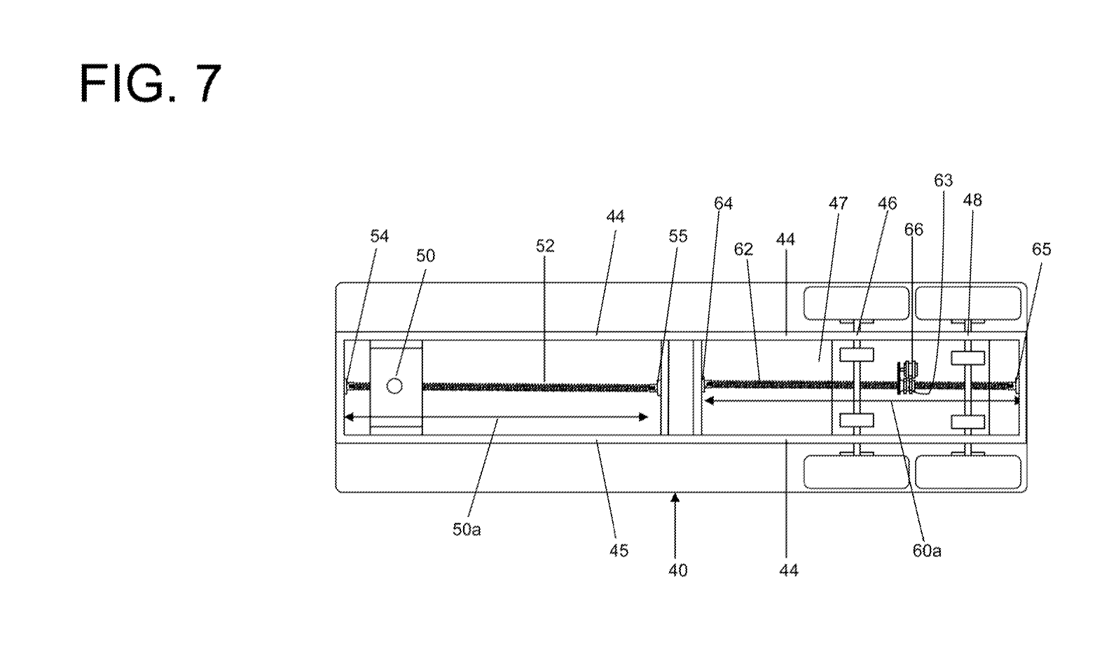

Turning now to FIGS. 7-9, by way of example and not limitation, in embodiments, a worm type locking device 51 may be employed. As shown therein, the locking device 51 may include a worm 52 and a traveling member 53. As shown, the traveling member 53 may extend circumferentially around the worm 52, whereby the threads of each intermesh. Also shown, the traveling member 53 may be secured to the towed anchor 50.

Those of ordinary skill in the art will appreciate that as the towing vehicle 20 tows the towed vehicle 40 that the towing anchor 30 pulls on the towed anchor 50 in a forward direction, for example during acceleration of the towing vehicle 20. Those of ordinary skill in the art will appreciate that as the towing vehicle 20 tows the towed vehicle 40 that the towing anchor 50 pushes on the towed anchor 50 in a rearward direction, for example during deceleration of the towing vehicle 20. Those of ordinary skill in the art will appreciate that as the towing anchor 30 pulls or pushes on the towed anchor 50, that the longitudinal force vectors of these actions include a circumferential force component due to the helical nature of the threads on the worm 52 and the traveling member 53.

Advantageously, the intermeshing of the threads on the worm 52 and the traveling member 53 selectively lock the traveling member 53 and the towed anchor 50 in place so long as the circumferential force component is insufficient to overcome the friction between the threads. Those of ordinary skill in the art will appreciate that the angle of the threads and the dimension of the flanks of the threads may be designed to provide a sufficient level of frictional force between the worm 52 and the traveling member 53 and selectively inhibit longitudinal movement of the towed anchor 50 along the path of motion 50a of the towed anchor 50 and therefore selectively lock the position of the towed anchor 50 along the path of motion 50a.

As shown in FIGS. 7 and 8, to permit repositioning of the towed anchor 50, the worm 52 may be rotated via at least one torquing member, for example, torquing members 54, 55, which may, for example, and not limitation, be pneumatically, hydraulically, or electrically driven motors, to permit repositioning of the towing anchor 30. Advantageously, the torquing members 54, 55 need only supply sufficient torsional force to overcome the frictional force between the worm 52 and the traveling member 53 to permit longitudinal movement of the towed anchor 50 in response to relative speed differentials between the towing vehicle 20 and the towed vehicle 40. In particular, as the worm 52 rotates and the towing anchor 30 pulls on or pushes on the towed anchor 50, the towed anchor 50 may be urged to travel longitudinally along the towed vehicle 40 and along path of motion 50a in response to relative speed differentials between the towing vehicle 20 and the towed vehicle 40.

By way of example, and not limitation, the torquing members 54, 55 may rotate the worm 52 in a first direction, in a manner that overcomes frictional forces between the worm 52 and the traveling member 53. As this occurs, brakes to the towing vehicle 20 may be applied, for example, such that the towing vehicle 20 is caused to travel at a speed that is less than the speed of the towed vehicle 20. As the towing vehicle 20 travels at a speed that is less than the speed of the towed vehicle 40, the towing anchor 30 of the towing vehicle 20 may push on and urge the towed anchor 50 rearward along the towed vehicle 40 and produce repositioning of the towed anchor 50 rearward along the towed vehicle 40. Those of ordinary skill in the art will appreciate that in this manner the length L of the gap 130 may be decreased.

By way of another example, and not limitation, the torquing members 54, 55 may rotate the worm 52 in a second direction, opposite to the first direction, in a manner that is sufficient to overcome frictional forces between the worm 52 and the traveling member 53. As this occurs, brakes to the towed vehicle 40 may be applied, such that the towing vehicle 20 is caused to travel at a speed that exceeds the speed of the towed vehicle 40. As the towing vehicle 20 travels at a speed that exceeds the speed of the towed vehicle 40, the towing anchor 30 of the towing vehicle 20 may pull on and urge the towed anchor 50 forward along the towed vehicle 40 and produce repositioning of the towed anchor 50 forward along the towed vehicle 20. Those of ordinary skill in the art will appreciate that in this manner the length L of the gap 130 may be increased.

Advantageously, rather than requiring the use of relatively large, heavy, and powerful torquing members 54, 55 to both overcome the frictional force between the worm 52 and traveling member 53 and exert sufficient longitudinal force components to produce repositioning of the towed anchor 50, smaller, lighter, and less powerful torquing members 54, 55 may be used to overcome the frictional forces between the worm 52 and the traveling member 53 and the longitudinal force components required to produce repositioning of the towed anchor 50 may be generated, at least in part, and preferably, primarily, as a consequence of inertia and relative speed differentials between the towing vehicle 20 and the towed vehicle 40.

Upon the towed anchor 50 attaining a desired position, the torque members 54, 55, may cease rotating the worm 52, whereupon frictional forces between the worm 52 and the traveling member 53 once again lock the position of the towed anchor 50 in place. Those of ordinary skill in the art will appreciate that in this manner the towed anchor 50 may be selectively locked and unlocked in any position anywhere along a path of motion 50a of the towed anchor 50.

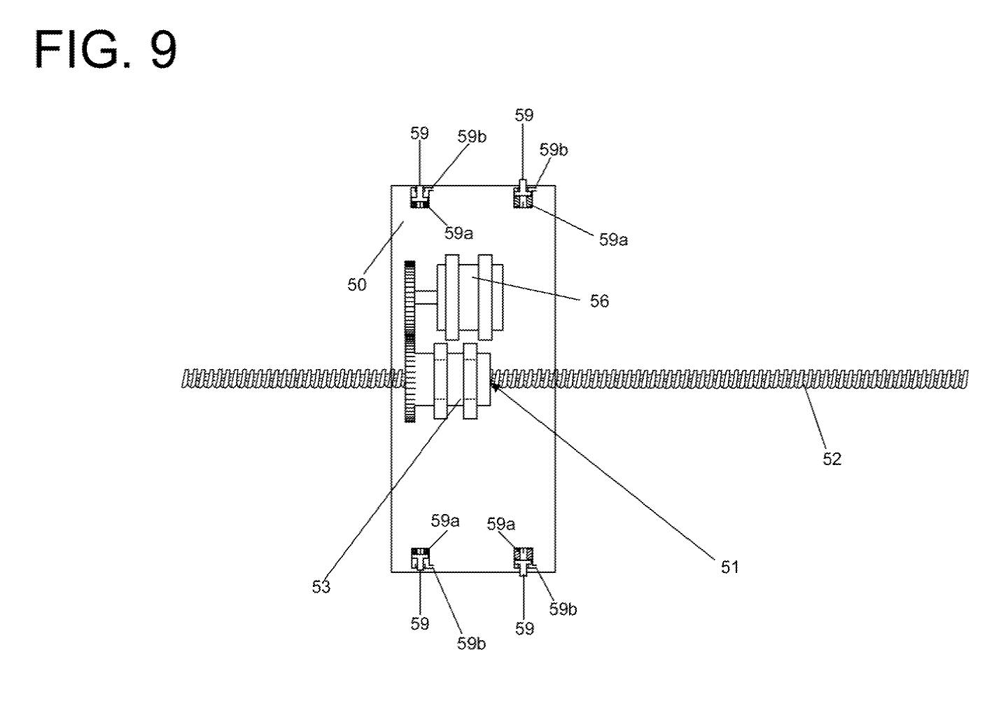

Alternatively or additionally, as shown in FIG. 9, in embodiments, the traveling member 53 may be rotated via at least one torquing member, for example, torquing member 56, which may, for example and not limitation, be pneumatically, hydraulically, or an electrically driven motor, to permit repositioning of the towed anchor 50. Advantageously, the torquing member 56 need only supply sufficient torsional force to overcome the frictional force between the worm 52 and the traveling member 53 to permit longitudinal movement of the towed anchor 50 in response to relative speed differentials between the towing vehicle 20 and the towed vehicle 40. In particular, as the traveling member 53 rotates and the towing anchor 30 pulls or pushes on the towed anchor 50, the towed anchor 50 to may be urged to travel longitudinally along the towed vehicle 40 and along path of motion 50a in response to relative speed differentials between the towing vehicle 20 and the towed vehicle 40.

By way of example, and not limitation, the torquing member 56 may rotate the traveling member 53 in a first direction, in a manner that is sufficient to overcome frictional forces between the worm 52 and the traveling member 53. As this occurs, brakes to the towing vehicle 20 may be applied, for example, such that the towing vehicle 20 is caused to travel at a speed that is less than the speed of the towed vehicle 40. As the towing vehicle 20 travels at a speed that is less than the speed of the towed vehicle 40, the towing anchor 50 of the towed vehicle 40 may push on and urge the towed anchor 50 rearward along the towed vehicle 40 and produce repositioning of the towed anchor 30 rearward along the towed vehicle 40. Those of ordinary skill in the art will appreciate that in this manner the length L of the gap 130 may be decreased.

By way of another example, and not limitation, the torquing member 56 may rotate the traveling member 53 in a second direction, opposite to the first direction, in a manner that is sufficient to overcome frictional forces between the worm 52 and the traveling member 53. As this occurs, brakes to the towed vehicle 40 may be applied, such that the towing vehicle 20 is caused to travel at a speed that exceeds the speed of the towed vehicle 40. As the towing vehicle 20 travels at a speed that exceeds the speed of the towed vehicle 40, the towing anchor 30 of the towing vehicle 20 may pull on and urge the towed anchor 50 forward along the towed vehicle 40 and produce repositioning of the towed anchor 50 forward along the towed vehicle 40. Those of ordinary skill in the art will appreciate that in this manner the length L of the gap 130 may be increased.

Advantageously, rather than requiring the use of a relatively large, heavy, and powerful torquing member 56 to both overcome the frictional force between the worm 52 and traveling member 53 and exert sufficient longitudinal force components to produce repositioning of the towed anchor 50, a smaller, lighter, and less powerful torquing member 56 may be used to overcome the frictional forces between the worm 52 and the traveling member 53 and the longitudinal force components required to produce repositioning of the towed anchor 50 may be generated, at least in part, and preferably, primarily, as a consequence of inertia and relative speed differentials between the towing vehicle 20 and the towed vehicle 40.

Upon the towed anchor 50 attaining a desired position, the torque member 56 may cease rotating the traveling member 53, whereupon frictional forces between the worm 52 and the traveling member 53 once again lock the position of the towed anchor 50 in place. Those of ordinary skill in the art will appreciate that in this manner the towed anchor 50 may be selectively locked and unlocked in any position anywhere along a path of motion 50a of the towed anchor 50.

While it is within the scope of embodiments to utilize alternative types of locking devices, advantageously, a worm type locking devices 51 provides a greater degree of flexibility in locking the position of the towed anchor 50 anywhere along the path of motion 50a of the towed anchor 50. Furthermore, while it is in the scope of embodiments to rotate either the worm 52 or the traveling member 53, rotating both at the same time in opposite directions may also occur.

Turning now to FIGS. 1-3 and 9, by way of example, and not limitation, a locking device 57 of an alternative embodiment is depicted. As shown therein, the locking device 57 may include a plurality of locking passages 58 and one or more locking pins 59. As shown, in FIGS. 1-3, the passages 58 may be defined within the towed vehicle frame 44 along which the towed anchor 50 slides or rolls along during repositioning. As shown in FIG. 9, the towed anchor 50 may include a plurality of locking pins 59 that are retractable to permit movement of the towed anchor 50 and extendable to lock the position of the towed anchor 50 in place. As shown, the locking pins 59 may be biased in an extended position by a spring 59a and may be retracted via pneumatic or hydraulic pressure supplied via port 59b. Advantageously, biasing the locking pins 59 in the extended position prevents movement of the towed anchor 50 in the event the pneumatic or hydraulic pressure supplied via port 59b fails.

According to another aspect of the present embodiment, as hereinafter discussed, one or more electronics 120 may control any locking device associated with the towed anchor 50, including, but not limited to, locking devices 51 and 57 for purposes of permitting relative speed differentials between the towing vehicle 20 and the towed vehicle 40 to produce repositioning of the towed anchor 50.

According to one aspect of the present embodiment, the axles 46, 48 may be repositioned along the towed vehicle 40 as the towing vehicle 20 and towed vehicle 40 travel, whereby axle load is determined according to the position of the axles 46, 48. According to another aspect of the present embodiment, the axles 46, 48 may be repositioned along the towed vehicle 40 as the towing vehicle 20 and towed vehicle 40 travel in order to adjust the load on the axles 24, 26, 28, 46, and 48 and in order to prevent the overloading of the axles 24, 26, 28, 46, and 48.

As shown in FIG. 2, as compared to FIGS. 1 and 3, as the towing vehicle 20 and the towed vehicle 40 travel, the axles 46, 48 may be moved forward along the towed vehicle 40. As shown in FIG. 3, as compared to FIGS. 1 and 2, as the towing vehicle 20 and the towed vehicle 40 travel, the axles 46, 48 may be moved rearward along the towed vehicle 40. Those of ordinary skill in the art will also appreciate that as the axles 46, 48 are repositioned, as shown in FIGS. 1-3, that the load distribution on the axles 24, 26, 28, 46, and 48 is adjusted.

According to yet another aspect of the present embodiment, relative speed differentials between the towed vehicle frame 44 and the axles 46, 48 produce repositioning of the axles 46, 48. Advantageously, as hereinafter discussed, one or more electronics 120 may monitor and/or control the speeds of towed vehicle frame 44 and the axles 46, 48 for purposes of producing repositioning of the axles 46, 48 in response to relative speed differentials between the towed vehicle frame 44 and the axles 46, 48.

According to one aspect of the present embodiment, a locking device selectively locks and unlocks the position of the axles 46, 48 along the towed vehicle 40, whereby as the towing vehicle 20 and towed vehicle 40 travel, relative speed differentials between the towed vehicle frame 44 and the axles 46, 48 produce repositioning of the axles 46, 48. It is within the scope of the present embodiment to utilize any type of device that is capable of selectively locking the position of the axles 46, 48 including, but not limited to, any pneumatically, hydraulically, mechanically, or electrically devices.

Turning now to FIG. 7, by way of example and not limitation, in embodiments, a worm type locking device 61 may be employed. As shown therein, the locking device 61 may include a worm 62 and a traveling member 63. As shown, the traveling member 63 may extend circumferentially around the worm 62, whereby the threads of each intermesh. Also shown, the traveling member 63 may be secured to an axle carriage 47, which mounts the axles 46, 48 to the towed vehicle 40.

Those of ordinary skill in the art will appreciate that as the towing vehicle 20 tows the towed vehicle 40 that the traveling member 63 on pulls on the worm 62 in a rearward direction, for example during acceleration of the towing vehicle 20 or braking of the towed vehicle 40. Those of ordinary skill in the art will appreciate that as the towing vehicle 20 tows the towed vehicle 40 that the traveling member 63 pushes on the worm 62 in a forward direction, for example during deceleration of the towing vehicle 20. Those of ordinary skill in the art will appreciate that as the worm 62 pulls or pushes on the traveling member 63, that the longitudinal force vectors of these actions include a circumferential force component due to the helical nature of the threads on the worm 62 and the traveling member 63.

Advantageously, the intermeshing of the threads on the worm 62 and the traveling member 63 selectively lock the traveling member 63, the axle carriage 47, and the axles 46, 48 in place so long as the circumferential force component is insufficient to overcome the friction between the threads. Those of ordinary skill in the art will appreciate that the angle of the threads and the dimension of the flanks of the threads may be designed to provide a sufficient level of frictional force between the worm 62 and the traveling member 63 and selectively inhibit longitudinal movement of the traveling member 63, the axle carriage 47, and the axles 46, 48 along the path of motion 60a of the axles 46, 48 and therefore selectively lock the position of the axles 46, 48 along the path of motion 60a.

As shown in FIG. 7, to permit repositioning of the axles 46, 48, the worm 62 may be rotated via at least one torquing member, for example, torquing members 64, 65, which may, for example, and not limitation, be pneumatically, hydraulically, or electrically driven motors. Advantageously, the torquing members 64, 65 need only supply sufficient torsional force to overcome the frictional force between the worm 62 and the traveling member 63 to permit longitudinal movement of the axles 46, 48 in response to speed differentials between the towed vehicle frame 44 and the axles 46, 48. In particular, as the traveling member 63 pulls on or pushes on the worm, the axles 46, 48 may be urged to travel longitudinally along the towed vehicle 40 and along path of motion 60a in response to relative speed differentials between the towed vehicle frame 44 and the axles 46, 48.

By way of example, and not limitation, the torquing members 64, 65 may rotate the worm 62 in a first direction, in a manner that overcomes frictional forces between the worm 62 and the traveling member 63. As this occurs, brakes to the towing vehicle 20 may be applied, for example, such that the towed vehicle frame 44 is caused to travel at a speed that is less than the speed of the axles 46, 48. As the towed vehicle frame 44 travels at a speed that is less than the speed of the towed vehicle 40, the traveling member 63 may move forward along the towed vehicle 40 and produce forward repositioning of the axle carriage 47 and the axles 46, 48.

By way of another example, and not limitation, the torquing members 64, 65 may rotate the worm 62 in a second direction, opposite to the first direction, in a manner that is sufficient to overcome frictional forces between the worm 62 and the traveling member 63. As this occurs, brakes to the towed vehicle 40 may be applied, such that the axles 46, 48 are caused to travel at a speed that is less than the speed of the towed vehicle frame 44. As the axles 46, 48 travel at a speed that is less than the speed of the towed vehicle 40, the traveling member 63 may move rearward along the towed vehicle 40 and produce reward repositioning of the axle carriage 47 and the axles 46, 48.

Advantageously, rather than requiring the use of relatively large, heavy, and powerful torquing members 64, 65 to both overcome the frictional force between the worm 62 and traveling member 63 and exert sufficient longitudinal force components to produce repositioning of the axles 46, 48, smaller, lighter, and less powerful torquing members 64, 65 may be used to overcome the frictional forces between the worm 62 and the traveling member 63 and the longitudinal force components required to produce repositioning of the axles 46, 48 may be generated, at least in part, and preferably, primarily, as a consequence of inertia and relative speed differentials between the towed vehicle frame 44 and the axles 46, 48.

Upon the axles 46, 48 attaining a desired position, the torque members 64, 65, may cease rotating the worm 62, whereupon frictional forces between the worm 62 and the traveling member 63 once again lock the position of the axles 46, 48 in place. Those of ordinary skill in the art will appreciate that in this manner the axles 46, 48 may be selectively locked and unlocked in any position anywhere along a path of motion 60a of the axles 46, 48.

Alternatively or additionally, as shown in FIG. 7, in embodiments, the traveling member 63 may be rotated via at least one torquing member, for example, torquing member 66, which may, for example and not limitation, be pneumatically, hydraulically, or an electrically driven motor, to permit repositioning of the axles 46, 48. Advantageously, the torquing member 66 need only supply sufficient torsional force to overcome the frictional force between the worm 62 and the traveling member 63 to permit longitudinal movement of the axles 46, 48 in response to relative speed differentials between the towed vehicle frame 44 and the axles 46, 48. In particular, as the traveling member 63 rotates and the traveling member 63 pulls or pushes on the worm 62, the axles 46, 48 may be urged to travel longitudinally along the towed vehicle 40 and along path of motion 60a in response to relative speed differentials between the towed vehicle frame 44 and the axles 46, 48.

By way of example, and not limitation, the torquing members 66 may rotate the traveling member 63 in a first direction, in a manner that overcomes frictional forces between the worm 62 and the traveling member 63. As this occurs, brakes to the towing vehicle 20 may be applied, for example, such that the towed vehicle frame 44 is caused to travel at a speed that is less than the speed of the axles 46, 48. As the towed vehicle frame 44 travels at a speed that is less than the speed of the towed vehicle 40, the traveling member 63 may move forward along the towed vehicle 40 and produce forward repositioning of the axle carriage 47 and the axles 46, 48.

By way of another example, and not limitation, the torquing member 66 may rotate the traveling member 63 in a second direction, opposite to the first direction, in a manner that is sufficient to overcome frictional forces between the worm 62 and the traveling member 63. As this occurs, brakes to the towed vehicle 40 may be applied, such that the axles 46, 48 are caused to travel at a speed that is less than the speed of the towed vehicle frame 44. As the axles 46, 48 travel at a speed that is less than the speed of the towed vehicle 40, the traveling member 63 may move rearward along the towed vehicle 40 and produce reward repositioning of the axle carriage 47 and the axles 46, 48.

Advantageously, rather than requiring the use of a relatively large, heavy, and powerful torquing member 66 to both overcome the frictional force between the worm 62 and traveling member 63 and exert sufficient longitudinal force components to produce repositioning of the axles 46, 48, a smaller, lighter, and less powerful torquing member 66 may be used to overcome the frictional forces between the worm 62 and the traveling member 63 and the longitudinal force components required to produce repositioning of the axles 46, 48 may be generated, at least in part, and preferably, primarily, as a consequence of inertia and relative speed differentials between the towed vehicle frame 44 and the axles 46, 48.

Upon the axles 46, 48 attaining a desired position, the torque member 66 may cease rotating the traveling member 63, whereupon frictional forces between the worm 62 and the traveling member 63 once again lock the position of the axles 46, 48 in place. Those of ordinary skill in the art will appreciate that in this manner the axles 46, 48 may be selectively locked and unlocked in any position anywhere along a path of motion 60a of the axles 46, 48.

While it is within the scope of embodiments to utilize alternative types of locking devices, advantageously, a worm type locking devices 61 provides a greater degree of flexibility in locking the position of the axles 46, 48 anywhere along the path of motion 60a of the axles 46, 48. Furthermore, while it is in the scope of embodiments to rotate either the worm 62 or the traveling member 63, rotating both at the same time in opposite directions may also occur.

Turning now to FIGS. 1-3, by way of example, and not limitation, a locking device 67 of an alternative embodiment is depicted. As shown therein, the locking device 67 may include a plurality of locking passages 68 and one or more locking pins 69. As shown, in FIGS. 1-3, the passages 68 may be defined within a towed vehicle frame 44 along which the axle carriage 47 slides or rolls along during repositioning. Also shown, the axle carriage 47 may include a plurality of locking pins 69 that are retractable to permit movement of the axles 46, 48 and extendable to lock the position of the axles 46, 48 in place. Similarly as shown with respect to the towing anchor 30 and towed anchor 50, the locking pins 69 may be biased in an extended position by a spring, such as 39a, 59a and may be retracted via pneumatic or hydraulic pressure supplied via port, such as port 39b, 59b. Advantageously, biasing the locking pins 69 in the extended position prevents movement of the axles 46, 48 in the event the pneumatic or hydraulic pressure supplied via port fails.

According to another aspect of the present embodiment, as hereinafter discussed, one or more electronics 120 may control any locking device associated with the towed axles 46, 48, including, but not limited to, locking devices 61 and 67 for purposes of permitting relative speed differentials between the towed vehicle frame 44 and the axles 46, 48 to produce repositioning of the axles 46, 48.

According to another aspect of the present embodiment, the length L of the gap 130, the load on the axles 24, 26, 28, 46, 48, the position of the towing anchor 30, the position of the towed anchor 50, and/or the position of the axles 46, 48 may be adjusted automatically by one or more electronics 120, which may be include any type of electronic devices, including, but not limited to, processors or microprocessors, for example. The one or more electronics 120 may be provided on the towing vehicle 20 and/or the towed vehicle 40. As shown, the one or more electronics 120 may generate control signals, represented schematically as 120a, 120b, 120c, that are used to control locking devices, including, but not limited to locking devices 31, 37, 51, 57, 61, 67, associated with the towing anchor 30, the towed anchor 50, and the axles 46, 48.

According to another aspect of the present embodiment, the one or more electronics 120 may generate control signals 120d, 120e, 120f that are used to control the brakes 23 on the towing vehicle 20, the brakes 43 on the towed vehicle 40 and/or the towing vehicle powertrain 27 in order to generate relative speed differentials between the towing vehicle 20 and towed vehicle 40 for purposes of adjusting the length L of the gap 130, the load on the axles 24, 26, 28, 46, 48, the position of the towing anchor 30, or the position of the towed anchor 50. By way of example, and not limitation, locking devices, including, but not limited to locking devices 31, 37, 51, or 57 may be selectively disengaged such that relative speed differentials may produce repositioning of the towing anchor 30 or the towed anchor 50. By way of example, the towing anchor 30 may be moved forward and the length L of the gap reduced by disengaging locking device 31 or 37 and applying brakes 23, whereby the towed vehicle 40 travels at a speed that is greater than the speed of the towing vehicle 20. By way of example, the towing anchor 30 may be moved rearward and the length L of the gap increased by disengaging locking device 31 or 37 and by using the powertrain 27 to cause the towing vehicle 20 to travel at a speed that is greater than the towed vehicle 40. Those of ordinary skill in the art will appreciate that in a similar manner the position of the towed anchor 50 may be adjusted. Those of ordinary skill in the art will appreciate that relative speed differentials may be generated in other manners, within the scope of the present embodiment, including for example, via drag or the road grade.

According to another aspect of the present embodiment, the one or more electronics 120 may generate control signals 120d, 120e, 120f that are used to control the brakes 23 on the towing vehicle 20, the brakes 43 on the towed vehicle 40 and/or the towing vehicle powertrain 27 in order to adjust the load on the axles 24, 26, 28, 46, 48 and the position of the axles 46, 48. By way of example, and not limitation, locking devices, including, but not limited to locking device 61 or 67 may be selectively disengaged such that relative speed differential between the axles 46, 48 and the towed vehicle frame 44 may cause repositioning of the axles 46, 48. By way of example, the axles 46, 48 may be moved rearward by disengaging locking device 26 or 67 and applying brakes 43, whereby the towed vehicle frame 44 travels at a speed that is greater than the speed of the axles 46, 48. By way of example, the axles 46, 48 may be moved forward by disengaging locking device 61 or 67 and by using the brakes 23 on the towing vehicle 20 to cause the axles 46, 48 to travel at a speed that is greater than the speed of the towed vehicle frame 44. Those of ordinary skill in the art will appreciate that relative speed differentials may be generated in other manners, within the scope of the present embodiment, including for example, via the towing vehicle powertrain 27, drag, or the road grade

The one or more electronics may have an associated memory 140. Spacing specifications for various conditions may be stored in memory 140 in the form of a table for example. Also, shown, the one or more electronics 120 may communicate with a variety of sensors including, but not limited to, position sensors 150, 151, 152 that monitor the position of the towing anchor 30, towed anchor 50, and axles 46, 48, position sensor 153 that monitors the length L of the gap 130, sensor 154 that monitors the speed of the towing vehicle 20, and load sensors 155 that monitor the loads on the axles 24, 26, 28, 46, 48, and a steering angle sensor 156 that monitors the steering angle of the towing vehicle 20.

According to one aspect of the present embodiment, the one or more electronics 120 may reposition the towing anchor 30, the towed anchor 50, and the axles 46, 48 with reference to any number of operating conditions of the towing vehicle 20 and/or towed vehicle 40.

By way of example, and not limitation, the one or more electronics 120 may monitor the speed indicted by speed sensor 154, including, for example a speedometer and make adjustments to the position of the towing anchor 30, towed anchor 50, and axles 46, 48 to achieve a specific length L of the gap 130 according to the speed of the towing vehicle 20. In doing so, the one or more electronics 120 may also monitor the load on the axles 24, 26, 28, 46, 48 and position the towing anchor 30, towed anchor 50, and axles 46, 48 in a manner that achieves the desired specific length L of the gap 130, yet prevents overloading of the axles 24, 26, 28, 46, 48. By way of example, and not limitation, when traveling at relatively high speeds the one or more electronics 120 may reduce the length L of the gap 130 to reduce drag and increase fuel economy. By way of example, and not limitation, when traveling at slower speeds, where drag has less of an effect on fuel economy, or when turning, where it is necessary to have a sufficient length L to permit towed vehicle 40 articulation relative to the towing vehicle 20, the one or more electronics 120 may increase the length L of the gap 130.

By way of another example, and not limitation, the one or more electronics 120 may monitor the position of the towing vehicle 20 along on a expected travel route, including, for example, with the assistance of a gps system (not shown), and make adjustments to the position of the towing anchor 30, towed anchor 50, and axles 46, 48 to achieve a specific length L of the gap 130 according to the position of the towing vehicle 20 along the expected travel route. In doing so the one or more electronics 120 may also monitor the load on the axles 24, 26, 28, 46, 48 and position the towing anchor 30, towed anchor 50, and axles 46, 48 in a manner that achieves the desired specific length L of the gap 130, yet prevents overloading of the axles 24, 26, 28, 46, 48. By way of example, and not limitation when the towing vehicle 20 is traveling on an interstate highway where sharp turns are generally not present, the one or more electronics 120 may reduce the length L of the gap 130 to reduce drag and increase fuel economy. By way of example, and not limitation, when traveling on local roads where sharp turns may be encountered, the one or more electronics 120 may increase the length L of the gap 130.

By way of yet another example, and not limitation, the one or more electronics 120 may monitor the steering angle of the truck tractor or the activation of turn signals and make adjustments to the position of the towing anchor 30, towed anchor 50, and axles 46, 48 to achieve a specific length L of the gap 130 according to steering angle or activation of turn signals. In doing so the one or more electronics 120 may also monitor the load on the axles 24, 26, 28, 46, 48 and position the towing anchor 30, towed anchor 50, and axles 46 in a manner that achieves the desired specific length L of the gap, yet prevents overloading of the axles 24, 26, 28, 46, 48. By way of example, and not limitation when the towing vehicle 20 is traveling substantially straight or when the turn signals are deactivated, the one or more electronics 120 may reduce the length L of the gap 130 to reduce drag and increase fuel economy. By way of example, and not limitation, when the towing vehicle 20 is turning or the turn signals are activated, the one or more electronics 120 may increase the length L of the gap 130 to allow sufficient towed vehicle 40 articulation relative to the towing vehicle 20.

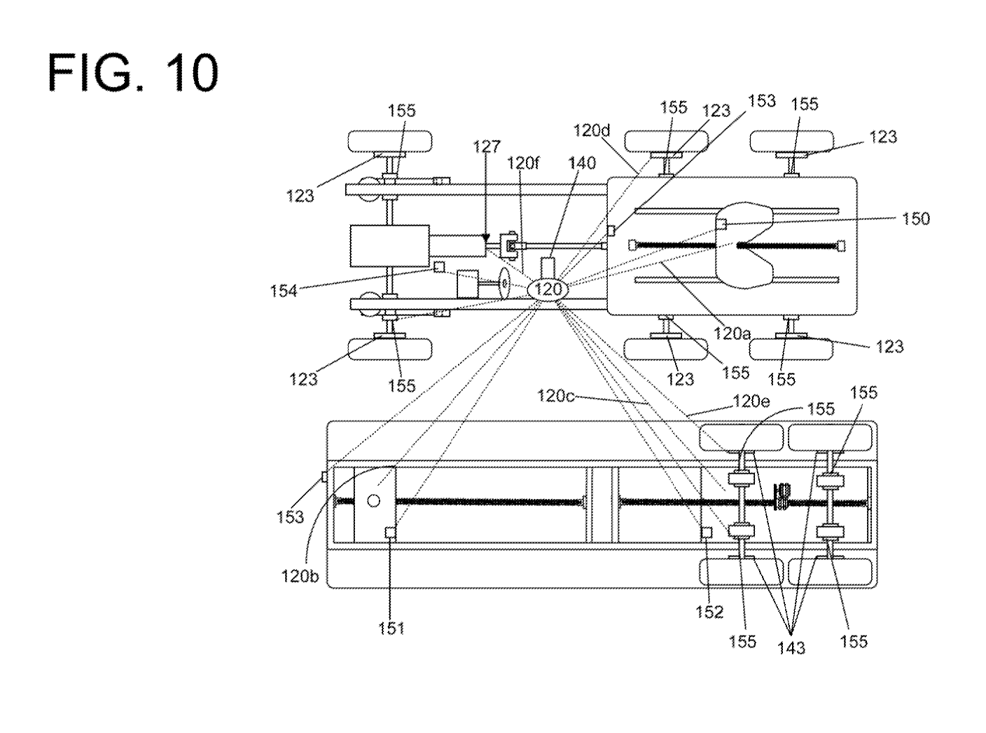

Although FIG. 10 depicts an automated control system which may be used to adjust the length L of the gap 130, the load on the axles 24, 26, 28, 46, 48, the position of the towing anchor 30, the position of the towed anchor 50, and/or the position of the axles 46, 48, in alternative embodiments the system may be manually controlled in whole or in part. By way of example, and not limitation, in an alternative embodiment a user may determine the length L of the gap 130 and an automated system may determine an appropriate position of the towing anchor 30, position of the towed anchor 50, and/or the position of the axles 46, 48 that achieves the specified length L of the gap 130 without overloading the axles 24, 26, 28, 46, 48.

Advantageously, the embodiments described in relation to FIGS. 1-10 allow for the length L of the gap 130 to be adjusted according to any number of operating conditions of the towing vehicle 20 and towed vehicle 40, including, by way of example, and not limitation in a manner that takes into account the load on the axles 24, 26, 28, 46, 48. By way of example, in the truck tractor/trailer arrangement depicted and operated in accordance with the principals described in relation to FIGS. 1-10 wherein a 53 ft. trailer is provided that includes a gross weight of 79006 lbs. and a 34,000 lbs. trailer suspension rating and wherein a truck tractor is provided that includes a 12,000 lbs. front suspension rating, a 34,000 rear tandem suspension rating, wherein the fifth wheel is centered 1 ft in front of the center of the rear tandem suspension, i.e. 1 ft. forward of the midpoint between the axles, wherein only the fifth wheel and kingpin are repositioned to reduce the length of the gap, the fifth wheel may be moved 3.32 inches and the kingpin may be moved 7.27 inches, for a combined total of 10.59 inch reduction in the length of the gap before the load on the front axle of the truck tractor reaches a maximum limit. Improvements in the ability to reduce the gap length can also be achieved by moving the fifth wheel and the trailer axles with or without moving the kingpin. Similarly, moving only the kingpin and the trailer axles the substantially the same distance will allow any gap length between the cab and trailer to be achieved without overloading any of the axles on the truck tractor or the trailer.

Although the present embodiment has been described in the context of an adjustable towing system 210 wherein inertia and relative speed differentials produce repositioning of the towing anchor 30, the towed anchor 50, and towed vehicle axles 46, 48, in alternative embodiments, relative speed differentials may produce repositioning of at least one of the towing anchor 30 and the towed anchor 50. By way of example, the towing anchor 30 may be repositionable and the towed anchor 50 may be fixed, the towed anchor 50 may be repositionable and the towing anchor 30 may be fixed, with or without repositioning the axles 46, 48. Furthermore, although the adjustable towing system 10 has been described in the context of a towing vehicle 20 provided with axles 24, 26, 28 and a towed vehicle 40 provided with axles 46, 48, in alternative embodiments the number of axles may be more or less.

The detailed descriptions of the above embodiments are not exhaustive descriptions of all embodiments contemplated by the inventors to be within the scope of the invention. The present description depicts specific examples to teach those skilled in the art how to make and use the best mode of the invention. For the purpose of teaching inventive principles, some conventional aspects have been simplified or omitted. By way of example, and not limitation on or more dampers (not shown), which may be variable in nature, may be provided to ensure a smooth and controlled rate transition of the towing anchor 30, towed anchor 50, or axles 46, 48 during repositioning.

Those skilled in the art will appreciate variations from these examples that fall within the scope of the invention. By way of example, in some embodiments, additional conditions may be placed on deciding when to adjust the length L of the gap 130. For example, even though a predetermined vehicle speed may have been reached, an additional condition may specify that this speed be maintained for predetermined period of time before adjusting the length L of the gap 130. If the vehicle speed is increasing and exceeds a pre-specified speed value, the length L of the gap 130 between cab 222 and towed vehicle 40 may be decreased based on a specified spacing value. If the vehicle speed is decreasing and falls below a pre-specified value, the length L of the gap 130 between cab 222 and towed vehicle 40 may be increased based on a specified spacing value.

In addition to previously mentioned vehicle operating conditions, additional conditions may also be utilized to determine adjustments to the length L of the gap 130. These conditions may include, but are not limited to, braking, a (vehicle) transmission gear setting of the powertrain 27, a (vehicle) transmission range setting of the powertrain 27, activation of a cruise control setting for the vehicle and operation of the vehicle for a preselected period of time at a pre-specified steady state speed. The specification may state that the length L of the gap 130 should be adjusted by a particular amount if the vehicle is traveling for more than one minute at fifty miles per hour, for example.

An increased transmission gear setting and increased transmission range setting may indicate an increase in the vehicle speed and therefore, a decrease in the length L of the gap 130 between the cab and the trailer. Conversely a decreased transmission gear setting and decreased transmission range setting may indicate a decrease in the vehicle speed and therefore, an increase in the length L of the gap 130 between the towing vehicle 20 and the towed vehicle 40.

The towing anchor 30 and towed anchor 50 may be set at an initial setting such as that corresponding to a stationary vehicle. As the vehicle moves, the vehicle operating condition may be monitored to determine if one or more pre-selected events have occurred that warrant an adjustment to the length L of the gap 130. The pre-selected events may be reaching or passing a certain speed, braking, a particular transmission gear setting, a particular transmission range setting, steering wheel angle, location along an expected travel route, etc. A determination may be made at step as to whether a pre-selected event has taken place with the respect to the operating condition of the vehicle.

If a pre-specified event has taken place, one or more electronics 120 may retrieve a spacing value for the pre-selected event from memory 540. The one or more electronics 120 may also monitor the load on the axles 24, 26, 28, 46, 48. The one or more electronics 120 may determine a particular position value for the towing anchor 30, towed anchor 50, or axles 46, 48 in order to achieve a desired spacing value without overloading the axles 24, 26, 28, 46, 48. The one or more electronics 120 may then affect a relative speed differential that achieves the particular position value.

Exemplary embodiments as described may also provide safety aspects to vehicle operation in adverse weather related conditions. For example, as a vehicle slows down due to snowy or icy conditions, the increased spacing between the cab and trailer would prevent the so-called “jack-knifing” of the vehicle.

It will be appreciated that procedures described above may be carried out repetitively as necessary to control a vehicle. To facilitate understanding, many aspects of the invention are described in terms of sequences of actions that can be performed by, for example, elements of a programmable computer system. It will be recognized that the various actions could be performed by a combination of specialized circuits and mechanical elements. The control signals for moving the towing anchor 30, the towed anchor 50, and the axles 46, 48 may be generated by an electronic controller. The circuits may be discrete logic gates interconnected to perform a specialized function or application-specific integrated circuits.

Moreover, the monitoring and control signals can additionally be considered to be embodied within any form of computer program product or a computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport a computer program product for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM, EEPROM, or Flash memory), an optical fiber, and a portable compact disc read-only memory (CD-ROM).

Persons skilled in the art will recognize that certain elements of the above-described embodiments and examples may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention is determined from the appended claims and equivalents thereof.

I claim:

1. An adjustable towing system, comprising:
a towing vehicle;
a towed vehicle;
a towing anchor located on the towing vehicle;
a towed anchor located on the towed vehicle and connected to the towing anchor, whereby the towing vehicle tows the towed vehicle;
a gap defined between the towing vehicle and the towed vehicle, wherein said gap is provided with a length; and
at least one locking device that selectively locks and unlocks the position of the towing anchor or the towed anchor, whereby as the towing vehicle and towed vehicle travel, relative speed differentials between the towing vehicle and towed vehicle produce repositioning of at least one of the towing anchor or the towed anchor in order to adjust the length of the gap.

2. The adjustable towing system according to claim 1 wherein at least one of the towing anchor or the towed anchor is repositionable longitudinally along the respective towing vehicle or the towed vehicle.

3. The adjustable towing system according to claim 1, wherein;
the at least one locking device includes a first locking device and a second locking device;
the first locking device selectively locks and unlocks the position of the towing anchor, whereby as the towing vehicle and towed vehicle travel, relative speed differentials between the towing vehicle and towed vehicle produce repositioning of the towing anchor in order to adjust the length of the gap; and
the second locking device selectively locks and unlocks the position of the towed anchor, whereby as the towing vehicle and towed vehicle travel, relative speed differentials between the towing vehicle and towed vehicle produce repositioning of the towed anchor in order to adjust the length of the gap.

4. The adjustable towing system according to claim 1, wherein:
the towing vehicle is a truck tractor and the towing anchor is a fifth wheel; and
the towed vehicle is a trailer and the towed anchor is a kingpin.

5. The adjustable towing system according to claim 1, further comprising one or more electronics that monitor the speed of at least one of the towing vehicle or towed vehicle and control the speed of at least one of the towing vehicle or the towed vehicle in order to generate the relative speed differentials.

6. The adjustable towing system according to claim 1, further comprising one or more electronics that control the locking and unlocking of the at least one locking device whereby as the towing vehicle and towed vehicle travel, relative speed differentials between the towing vehicle and towed vehicle produce repositioning of at least one of the towing anchor or the towed anchor in order to adjust the length of the gap.

7. The adjustable towing system according to claim 1, wherein:
the towing vehicle includes at least one axle;
the towed vehicle includes at least one axle; and
the at least one locking device selectively locks and unlocks the position of the towing anchor or the towed anchor, whereby as the towing vehicle and towed vehicle travel, relative speed differentials between the towing vehicle and towed vehicle produce repositioning of at least one of the towing anchor or the towed anchor in order to adjust load on the axles and prevent axle overloading.

8. The adjustable towing system according to claim 1, wherein:
the at least one locking device includes a worm and a traveling member that selectively locks the position of the towing anchor or towed anchor anywhere along a path of motion of the towing anchor or the towed anchor.

9. The adjustable towing system according to claim 1, wherein:
the towing vehicle includes at least one axle;
the towed vehicle includes at least one axle and a frame; and
another locking device is provided that selectively locks and unlocks the position of the at least one axle on the towed vehicle, whereby as the towing vehicle and towed vehicle travel, relative speed differentials between the towed vehicle frame and the at least one axle of the towed vehicle produce repositioning of the at least one axle of the towed vehicle in order to adjust loads on the axles and prevent axle overloading.

10. The adjustable towing system according to claim 1, wherein:
the at least one locking device includes a first locking device and a second locking device;
the towing vehicle includes at least one axle;
the towed vehicle includes at least one axle;
another locking device is provided that selectively locks and unlocks the position of the at least one axle on the towed vehicle, whereby as the towing vehicle and towed vehicle travel, relative speed differentials between the towed vehicle frame and the at least one axle of the towed vehicle produce repositioning of the at least one axle of the towed vehicle in order to adjust loads on the axles and prevent axle overloading;
the first locking device selectively locks and unlocks the position of the towing anchor, whereby as the towing vehicle and towed vehicle travel, relative speed differentials between the towing vehicle and towed vehicle produce repositioning the towing anchor in order to adjust the length of the gap, adjust the load on the axles, and prevent axle overloading; and
the second locking device selectively locks and unlocks the position of the towed anchor, whereby as the towing vehicle and towed vehicle travel, relative speed differentials between the towing vehicle and towed vehicle produce repositioning of the towed anchor in order to adjust the length of the gap, adjust the load on the axles, and prevent axle overloading.

11. A method for adjusting a length of a gap between a towed vehicle and a towing vehicle as the towing vehicle and towed vehicle travel, wherein a towing anchor is located on the towing vehicle, a towed anchor is located on the towed vehicle and connected to the towing anchor, whereby the towing vehicle tows the towed vehicle, a gap is defined between the towing vehicle and the towed vehicle and provided with a length, and a locking device selectively locks and unlocks the position of the towing anchor or the towed anchor, the method comprising the step of:
using relative speed differentials between the towing vehicle and towed vehicle to produce repositioning of at least one of the towing anchor or the towed anchor in order to adjust the length of the gap as the towing vehicle and towed vehicle travel.

12. The method according to claim 11, wherein the step of using relative speed differentials between the towing vehicle and towed vehicle to produce repositioning of at least one of the towing anchor or the towed anchor in order to adjust the length of the gap as the towing vehicle and towed vehicle travel includes the step of using relative speed differentials between the towing vehicle and towed vehicle to produce repositioning of at least one of the towing anchor or the towed anchor longitudinally along the towing vehicle or the towed vehicle in order to adjust the length of the gap as the towing vehicle and towed vehicle travel.

13. The method according to claim 11, wherein the at least one locking device includes a first locking device and a second locking device, the first locking device selectively locks and unlocks the position of the towing anchor, the second locking device selectively locks and unlocks the position of the towed anchor and the step of using relative speed differentials between the towing vehicle and towed vehicle to produce repositioning of at least one of the towing anchor or the towed anchor in order to adjust the length of the gap as the towing vehicle and towed vehicle travel includes the step of using relative speed differentials between the towing vehicle and towed vehicle to produce repositioning of the towing anchor and the towed anchor in order to adjust the length of the gap as the towing vehicle and towed vehicle travel.

14. The method according to claim 11, wherein:
the towing vehicle is a truck tractor and the towing anchor is a fifth wheel; and
the towed vehicle is a trailer and the towed anchor is a kingpin.

15. The method according to claim 11, wherein the method further comprises the step of using one or more electronics to monitor the speed of at least one of the towing vehicle or towed vehicle and to control the speed of at least one of the towing vehicle or the towed vehicle in order to generate the relative speed differentials.

16. The method according to claim 11, wherein the method further comprises the step of using one or more electronics to control the locking and unlocking of the at least one locking device whereby the relative speed differentials between the towing vehicle and towed vehicle may produce repositioning of at least one of the towing anchor or the towed anchor in order to adjust the length of the gap.

17. The method according to claim 11, wherein:
the towing vehicle includes at least one axle;
the towed vehicle includes at least one axle; and
the method further comprises the step of using relative speed differentials between the towing vehicle and towed vehicle may produce repositioning of at least one of the towing anchor or the towed anchor in order to adjust load on the axles and prevent axle overloading.

18. The method according to claim 11, wherein the at least one locking device includes a worm and a traveling member the selectively lock the position of the towing anchor or towed anchor anywhere along a path of motion of the towing anchor or the towed anchor.

19. The method according to claim 11, wherein:
the towing vehicle includes at least one axle;
the towed vehicle includes at least one axle and a frame;
another locking device is provided that selectively locks and unlocks the position of the at least one axle on the towed vehicle; and
the method further comprises the step of using relative speed differentials between the towed vehicle frame and the at least one axle of the towed vehicle to produce repositioning of the at least one axle of the towed vehicle in order to adjust loads on the axles and prevent axle overloading.

20. The method according to claim 11, wherein:
the at least one locking device includes a first locking device and a second locking device;
the towing vehicle includes at least one axle;
the towed vehicle includes at least one axle;
another locking device is provided that selectively locks and unlocks the position of the at least one axle on the towed vehicle;
the first locking device selectively locks and unlocks the position of the towing anchor;
the second locking device selectively locks and unlocks the position of the towed anchor;
the step of using relative speed differentials between the towing vehicle and towed vehicle to produce repositioning of at least one of the towing anchor or the towed anchor in order to adjust the length of the gap as the towing vehicle and towed vehicle travel includes the steps of using relative speed differentials between the towing vehicle and towed vehicle to produce repositioning the towing anchor and the towed anchor in order to adjust the length of the gap, adjust the load on the axles, and prevent axle overloading; and
the method further comprising the step of using relative speed differentials between the towed vehicle frame and the at least one axle of the towed vehicle to produce repositioning of the at least one axle of the towed vehicle in order to adjust loads on the axles and prevent axle overloading.
